(19) United States
(12) Patent Application Publication
(10) Pub. No.: US 2003/0012283 A1
(43) Pub. Date: Jan. 16, 2003

(54) Motion vector detecting device and self-testing method therein

(75) Inventors: Kazuya Ishihara, Hyogo (JP); Stefan Scotzniovsky, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/160,002

(22) Filed: Jun. 4, 2002

(30) Foreign Application Priority Data
Jul. 6, 2001 (JP) 2001-206321

(51) Int. Cl. H04N 7/12

(52) U.S. Cl. 375/240.16; 375/240.24

(57) ABSTRACT

The motion vector detecting device with a self-testing function includes an operation circuit that calculates, by block matching, estimation values between a template block and respective image blocks in a search area, an input circuit including a select circuit that selects either data for testing or data being processed, for application to the operation circuit, a comparing circuit that detects, when the data being processed is supplied to the operation circuit, a motion vector of the template block based on the calculated results of the operation circuit, an operation result compressing circuit that performs, when the data for testing is applied to the operation circuit, a predetermined operation on the calculated results of the operation circuit to compress the results for outputting; and a test control circuit that controls data selection of the select circuit.

### BACKGROUND OF THE INVENTION

1. Field of the Invention

The present invention relates to a device for detecting motion vectors used for motion compensation of motion pictures, and more particularly to a motion vector detecting device for detecting motion vectors in accordance with a block matching method.

2. Description of the Background Art

For transmitting and storing image signals having a huge volume of data, a data compressing technique is indispensable for reducing the volume of data. Image data includes considerable redundancy caused, e.g., by correlation between neighboring pixels and visual properties of human beings. A data compression technique suppressing the redundancy of image data to reduce the volume of data to be transmitted is called high efficiency coding. An inter-frame (inter-field) predictive coding method is one of such high efficiency coding methods. The following processing is executed in this inter-frame (inter-field) predictive coding method.

Calculation is performed for each pixel to obtain a prediction error, which is a difference between pixel data in a current frame (or field) to be coded and pixel data at the same position in a reference frame (or field) preceding or succeeding in time the current frame. The prediction error calculated is used for the subsequent coding. According to this method, if the images contain less motion, a prediction error value is small because of high correlation between the frames (or fields), and thus the coding can be performed efficiently. If the images contain large motion, however, a large error occurs due to small correlation between the frames (or fields), to disadvantageously increase the volume of data to be transmitted. A motion-compensated inter-frame (or inter-field) predictive coding method is proposed as a method for overcoming the above-described problem.

FIG. 29 schematically shows a structure of a conventional predictive coding circuit. Referring to FIG. 29, the predictive coding circuit includes a motion compensation predictor 920 which detects a motion vector with respect to an image signal applied from a preprocessing circuit at an upstream stage to produce a reference image motion-compensated in accordance with the motion vector, a loop filter 922 which filters reference image pixel data read from motion compensation predictor 920, a subtractor 924 which obtains a difference between the input image signal and the output signal of loop filter 922, an orthogonal transformer 926 which performs an orthogonal transformation on the output signal (data) of subtractor 924, and a quantizer 928 which quantizes the output data of orthogonal transformer 926.

Motion compensation predictor 920 has a frame memory for storing pixel data of a preceding frame (or field), and produces the motion-compensated reference image pixel data in accordance with the pixel data of the preceding frame and the input image signal data. The motion-compensated reference image pixel data thus produced is stored in another buffer memory in motion compensation predictor 920. Loop filter 922 is provided for improving the image quality.

Orthogonal transformer 926 performs the orthogonal transformation such as DCT (Discrete Cosine Transform) on the data received from subtractor 924 in a unit of a block of a prescribed size (usually 8 by 8 pixels). Quantizer 920 quantizes the orthogonally transformed pixel data.

Motion compensation predictor 920 and subtractor 924 perform the inter-frame (or inter-field) prediction for motion compensation, to reduce temporal redundancy of the motion picture. Spatial redundancy in the motion picture is reduced by the orthogonal transformation by orthogonal transformer 926.

The coding circuit further includes an inverse quantizer 930 for transforming the data quantized by quantizer 928 into the original signal state, an inverse orthogonal transformer 932 for performing inverse orthogonal transformation on the output data of inverse quantizer 930, and an adder 934 for adding the output data of loop filter 922 to the output data of inverse orthogonal transformer 932. The inverse quantizer 930 and the inverse orthogonal transformer 932 produce image data to be used in inter-frame (or inter-field) prediction for the succeeding frame (or field). Thus, the inverse orthogonal transformer produces a difference value code to be transmitted. Adder 934 adds the output data of loop filter 922 to the inter-frame (or inter-field) difference data received from inverse orthogonal transformer 932, whereby the image data of the current frame (or field) is reproduced. The output data of adder 934 is written into the frame buffer included in motion compensation predictor 920. The way of detecting a motion vector mv in motion compensation predictor 920 will now be described.

It is assumed that an image 950 is formed of 352 dots (pixels) by 288 rows, as shown in FIG. 30. Image 950 is divided into a plurality of blocks each consisting of 16 by 16 pixels. The motion vectors are detected on a block-by-block basis. It is assumed that a search area, representing an area in which a motion vector is being searched for, is formed of a pixel block 956. This pixel block (search area) 956 is larger by ±16 pixels than a block 954 in the horizontal and vertical directions on the screen. Block 954 is located on the same position as a target block (template block) 952. Template block 952 is the current image block, and the motion vector for this template block 952 is detected in the following manner.

In FIG. 30, a block indicated by a vector (i, j) has a displacement (i, j) with respect to template block 952. This vector (i, j) is a motion vector candidate. An estimation function value is obtained, which is, for example, an absolute difference value sum (or squared difference sum) of the respective pixels in template block 952 and the corresponding pixels (on the same positions) in the block having the displacement vector (i, j). The operation of obtaining the estimation function value is executed on every displacement in a range of vectors (i, j) from (−16, −16) to (+16, +16). After the estimation function values are obtained for all the blocks (prediction image blocks) of the image blocks (search window blocks) in search area 956, a prediction image block having the minimum estimation function value is detected. The displacement that the prediction image block having the minimum estimation function value exhibits relative to block 954 is determined as the motion vector for the template block 952.

This motion vector detection is followed by calculating of the prediction error. The prediction image of a frame (or field) to be referred to, i.e., the frame (or field) preceding or succeeding in time the current frame (or field), is moved in accordance with the calculated motion vector. Image data of the frame (or field) to be referred to on the position displaced by the motion vector is regarded as the reference image, and the pixels of this reference image are used as predictive values. Prediction errors between the pixels on the same positions of the moved reference frame (or field) and the current frame (or field) are calculated, and transmitted together with the motion vector.

The current image and the reference image are divided into blocks, and the reference image block having the highest correlation with the current image block is obtained. This method is referred to as the block matching method. According to this block matching method, it is possible to detect a reference image block having the highest correlation in a unit of a pixel block. Thus, the prediction error can be decreased in size, enabling coding with high efficiency. It however is necessary to transmit a motion vector per pixel block. If the block size is reduced, the number of blocks is increased, so that the volume of information to be transmitted becomes large. If the block size is increased, the motion detection cannot be performed effectively. Accordingly, the pixel block size is generally set to 16 by 16 pixels, as described above.

In order to detect the reference image block having the highest correlation in a unit of a pixel block as described above, however, it is necessary to calculate, for each image block, errors with respect to all the reference image blocks included in a prescribed motion vector search window in the reference image. To this end, computing units operating in parallel to allow high-speed calculation of the same kinds should be provided, resulting in an increase in volume of the hardware.

When the volume of the hardware increases, the time required for the testing increases correspondingly. A defect in the hardware may result in inaccurate motion vector detection, in which case the motion-compensated inter-frame (or inter-field) predictive coding cannot be performed correctly.

A way of testing the hardware uses a register within the device as a scan path, wherein various kinds of test data are provided through the scan path to the device for operation, and the results thereof are taken out again through the scan path for verification of the operation. With this technique, however, an arrangement to make the register serve as the scan path is required, making the device more complicated and increased in size.

### SUMMARY OF THE INVENTION

An object of the present invention is to provide a motion vector detecting device of a simple structure which can test the hardware with high accuracy.

Another object of the present invention is to provide a motion vector detecting device of a simple structure which can perform various kinds of tests for the hardware with high accuracy.

Still another object of the present invention is to provide a motion vector detecting device of a simple structure which can test the hardware with high accuracy without using an external testing device.

A further object of the present invention is to provide a motion vector detecting device which can test the hardware with high accuracy without using a scan path.

Yet another object of the present invention is to provide a motion vector detecting device easy in downsizing which can test the hardware with high accuracy.

The motion vector detecting device with a self-testing function according to an aspect of the present invention is for detecting a motion vector of a template block within image data being processed, by searching one of image blocks in a search area within a reference image showing highest correlation with respect to the template block. The device includes: an operation circuit receiving data for the template block and data for the image blocks in the search area and calculating, by block matching, estimation values between the template block and respective ones of the image blocks in the search area, to output results of the operation; and an input circuit including a select circuit selecting either one of data for testing and externally supplied data being processed, for application to the operation circuit. The motion vector detecting device further includes: a comparing circuit connected to an output of the operation circuit and, when the data being processed is applied from the select circuit to the operation circuit, comparing the operation results between the template block and the respective image blocks in the search area output from the operation circuit, to detect the motion vector of the template block; an operation result compressing circuit connected to the output of the operation circuit and, when the data for testing is applied from the select circuit to the operation circuit, performing a predetermined operation on the operation results output from the operation circuit with respect to the data for testing, to compress the results for outputting; and a test control circuit for causing the select circuit to select one of the data being processed and the data for testing.

The select circuit can select and apply the data for testing to the operation circuit. This allows the operation circuit to perform a prescribed operation on the data for testing, and the compressing circuit to compress the results. The operation results and compressed results thereof are known in advance through simulation. If there is a defect in the hardware of the operation circuit, the results actually obtained by the operation circuit on the data for testing and then compressed would be different from the expected results by simulation. Thus, it is possible, from the test results, to readily determine whether the hardware in the operation circuit includes a defect or not. It is unnecessary to alter the structure of the operation circuit to enable the testing. Accordingly, an increase in circuit scale is prevented.

Preferably, the operation result compressing circuit includes a summing circuit for operating a total sum of the operation results output from the operation circuit.

The test can be done by such a simple operation for compression of obtaining the total sum of the operation results. Thus, the test circuit can be realized with a simple structure.

Still preferably, the motion vector detecting device further includes a test data generating circuit for generating a pseudo-random number as test data.

Using the pseudo-random number makes it possible to cause the hardware within the operation circuit to perform various kinds of operations, so that the accuracy of the test improves.

The self-testing method in a motion vector detecting circuit according to another aspect of the present invention is for detecting a motion vector of a template block within image data being processed, by searching one of image blocks in a search area within a reference image showing highest correlation with the template block. The method includes: the step of selecting either one of data for testing and externally received data being processed; and the step of receiving the data selected in the selecting step and calculating, by block matching, estimation values between the template block and respective ones of the image blocks in the search area, to output the results. The method further includes: the step of, when the data being processed is applied by the selecting step to the calculating step, comparing the operation results between the template block and the respective image blocks in the search area output in the calculating step, to detect the motion vector of the template block; the step of, when the data for testing is applied by the selecting step to the calculating step, performing a predetermined operation on the operation results output in the calculating step with respect to the data for testing, and compressing the results for outputting; and the step of controlling the selecting step such that the data being processed is selected in a normal operation and the data for testing is selected in a testing operation.

The data for testing can be selected for operation. This enables a prescribed operation to be performed on the data for testing, and the results to be compressed. The operation results from the data for testing and compressed results thereof are known in advance through simulation. If there is a defect in the hardware used for the operation, the results actually obtained by performing the operation on the data for testing and then compressed would be different from the expected results by simulation. Thus, it is possible, from the test results, to readily determine whether the hardware used for the operation includes a defect or not. It is unnecessary to alter the structure of the hardware used for the operation to enable the testing. Accordingly, an increase of the circuit size is prevented.

Preferably, the step of compressing the results for outputting includes the step of calculating a total sum of the operation results.

The test can be done by the simple operation for compression of obtaining the total sum of the operation results. Accordingly, the test circuit of a simple structure can be realized.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows an overall structure of the motion vector detecting device according to an embodiment of the present invention;

FIG. 2 schematically shows a structure of the input section shown in FIG. 1;

FIGS. 3A and 3B show search areas in the 4-to-1 sub-sampling mode and the 2-to-1 sub-sampling mode, respectively;

FIGS. 4 and 5 schematically show structures of template blocks in the 4-to-1 sub-sampling mode and the 2-to-1 sub-sampling mode, respectively;

FIG. 6 schematically shows a structure of the operation section shown in FIG. 1;

FIG. 7 schematically shows a structure of the operation unit shown in FIG. 6;

FIG. 8 schematically shows a structure of the element processor shown in FIG. 7;

FIG. 9 schematically shows structures of the shift unit and data buffer for the search window data shown in FIG. 6;

FIG. 10 schematically shows a structure of the search window data buffer shown in FIG. 9;

FIG. 11 schematically shows connections between the shift register columns and the delay buffers in the 4-to-1 sub-sampling mode;

FIG. 12 schematically shows connections between the shift register columns and delay buffers in the 2-to-1 sub-sampling mode;

FIG. 13 shows an example of screen division in the 4-to-1 sub-sampling mode;

FIG. 14 schematically shows structures of the search window block and the template block in the 4-to-1 sub-sampling mode;

FIG. 15 shows a state of storage of template block pixels in the operation units in the embodiment of the present invention;

FIG. 16 schematically shows a state of data stored in the operation section in the 4-to-1 sub-sampling mode;

FIG. 17 shows a state of the search window pixel data stored in the operation section after a lapse of one estimation value calculating cycle;

FIG. 18 shows a state of storage of the search window pixel data at the time of completion of estimation value calculation for one horizontal component;

FIG. 19 shows a state of storage of the search window pixel data for the next horizontal component;

FIG. 20 schematically shows a structure of the adder circuit shown in FIG. 7;

FIG. 21 schematically illustrates screen division in the 2-to-1 sub-sampling mode;

FIG. 22 schematically shows a structure of the template block in the 2-to-1 sub-sampling mode;

FIG. 23 schematically shows connection in the operation section in the 2-to-1 sub-sampling mode;

FIG. 24 schematically shows a state of storage of the pixel data in the 2-to-1 sub-sampling mode;

FIG. 25 shows a state of storage of the search window pixel data after a lapse of one estimation value calculating cycle;

FIG. 26 shows a state of storage of the search window pixel data upon completion of the operation for one horizontal component;

FIG. 27 shows a state of storage of the search window pixel data for the next horizontal component;

FIG. 28 is a block diagram of the test control section;

FIG. 29 schematically shows the structure of the conventional image coding device; and

FIG. 30 illustrates the motion vector detection.

### DESCRIPTION OF THE PREFERRED EMBODIMENTS

Hereinafter, the current image block for which a reference image block is to be searched is called a template block. A predetermined area in which the reference image block is to be searched is called a search window, and the reference image blocks within the search window are called search window data.

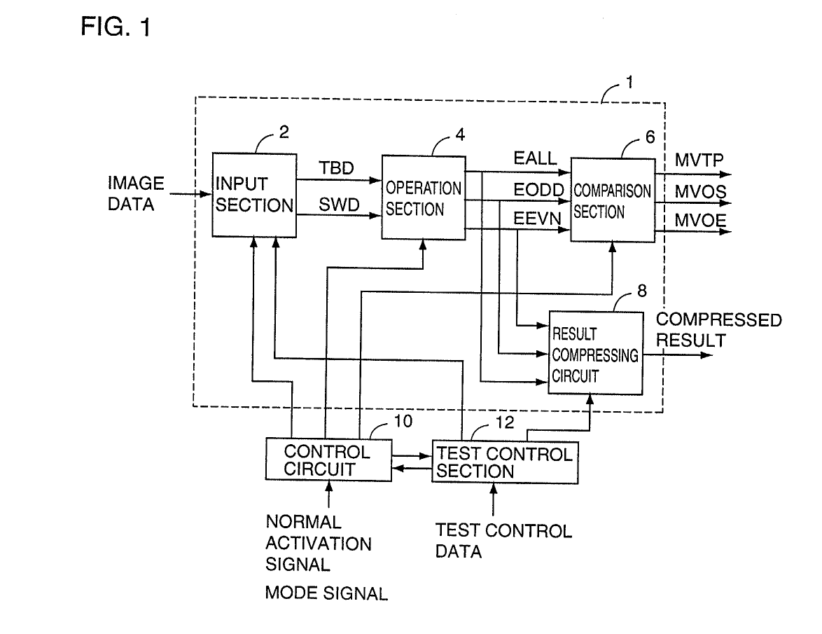

FIG. 1 schematically shows the overall structure of the motion vector detecting device according to an embodiment of the present invention. Referring to FIG. 1, the motion vector detecting device 1 includes: an input section 2 that, in a normal operation, receives input image data and performs sub-sampling of the input data at a prescribed sub-sampling rate to generate template block data TBD and search window pixel data SWD, and, in a testing operation, generates image data of a predetermined pattern or image data made of pseudo-random numbers as template block data TBD and search window pixel data SWD; and an operation section 4 that receives template block pixel data TBD and search window pixel data SWD from input section 2, and performs a prescribed arithmetic operation to generate estimation values EALL, EODD and EEVN.

Motion vector detecting device 1 further includes: a comparison section 6 that receives estimation values EALL, EODD and EEVN in parallel from operation section 4 and generates motion vectors MVTP, MVOS and MVOE in accordance with the received estimation values; a result compressing circuit 8 that repeatedly receives the estimation values from operation section 4 during the testing and performs a predetermined operation on the estimated values to output the estimation values after compression expressed with a less amount of data; a control circuit 10 that controls the motion vector detecting operations of input section 2, operation section 4 and comparison section 6; and a test control section 12 that receives test control data and controls, during the testing, the testing operations by input section 2 and result compressing circuit 8.

Result compressing circuit 8 performs the predetermined operation successively on the estimation values that are successively provided from operation section 4, and holds the result. For example, it adds the estimation value received from operation section 4 to the last value it was holding, and holds the result. Result compressing circuit 8 repeats this process. Accordingly, result compressing circuit 8 holds a certain value at the completion of a series of tests.

Motion vector detecting device 1 shown in FIG. 1 codes pixel data frame by frame. Operation section 4 includes an element processor array, of which specific structure will be described later, and produces, in parallel, estimation value EALL for a frame-based template block, estimation value EODD for a template block in an odd field, and estimation value EEVN for a template block in an even field. Comparison section 6 receives these estimation values EALL, EODD and EEVN, and generates motion vector MVTP for a template block, motion vector MVOS for an odd sub-template block, and motion vector MVOE for an even sub-template block. The sub-template block represents a field-based template block included in the frame-based template block.

In the normal operation, input section 2 may receive the search window pixel data and the template block pixel data in parallel on different ports, or may receive these data on the same port in a time division multiplex manner. The template block pixel data is applied, for example, in such a manner that image data supplied from a TV camera is stored in a memory, and then is supplied from this memory in a prescribed sequence. The search area pixel data is produced from prediction image data stored in a frame buffer (not shown).

The operation of motion vector detecting device 1 is controlled by control circuit 10 in the normal operation and by control circuit 10 and test control section 12 during the testing. Control circuit 10 and test control section 12 may be formed on the same chip as motion vector detecting device 1. Alternatively, they may be formed on another chip to be included in another image data coding control section.

Motion vector detecting device 1 shown in FIG. 1 performs the arithmetic operation in a pipeline manner in accordance with a clock signal (not shown). In operation section 4, the internal structure (i.e., transfer path of search window pixel data) is changed in accordance with the sub-sampling rate under the control of control circuit 10, and the estimation value is calculated based on sub-sampled pixel data.

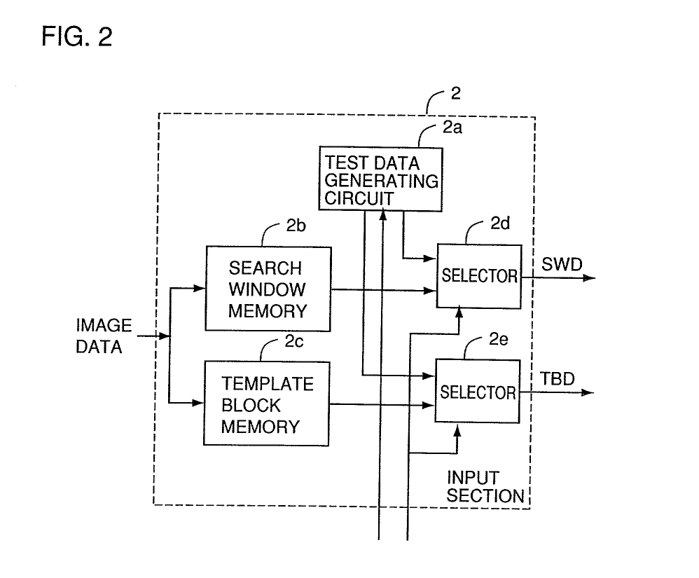

FIG. 2 schematically shows a structure of input section 2 shown in FIG. 1. Referring to FIG. 2, input section 2 includes: a test data generating circuit 2a formed of a pseudo-random number generating circuit and a fixed data providing circuit and generating a pseudo-random number or fixed data (all “0”, all “1”, or combination thereof) under the control of test control section 12; a search window memory 2b successively storing search window pixel data externally supplied; a template block memory 2c storing template block pixel data externally supplied; a selector 2d controlled by test control section 12 and selecting either one of the search window pixel data output from test data generating circuit 2a and the search window pixel data output from search window memory 2b for output; and a selector 2e controlled by test control section 12 and selecting either one of the template block pixel data output from test data generating circuit 2a and the template pixel data output from template block memory 2c for output.

Search window pixel data SWD is read out from search window memory 2b in a prescribed sequence, and template block pixel data TBD is read out from template block memory 2c.

The data output from test data generating circuit 2a, whether the pseudo-random number or the fixed data, has its contents known in advance. The operation being performed by operation section 4 is also known. Therefore, assuming that operation section 4 uses the data output from test data generating circuit 2a to perform the operation for a predetermined number of times and result compressing circuit 8 compresses the estimation values thus obtained, then the value to be obtained by result compressing circuit 8 should also be known in advance by simulation. Accordingly, comparing the test result actually output from result compressing circuit 8 and the result obtained by the simulation allows determination of whether the hardware in operation section 4 has any defect.

Although the sub-sampling rates of 2:1 and 4:1 have been described above, any rate of 2ⁿ:1 including 8:1 may generally be employed as the sub-sampling rate.

Structure of Search Area

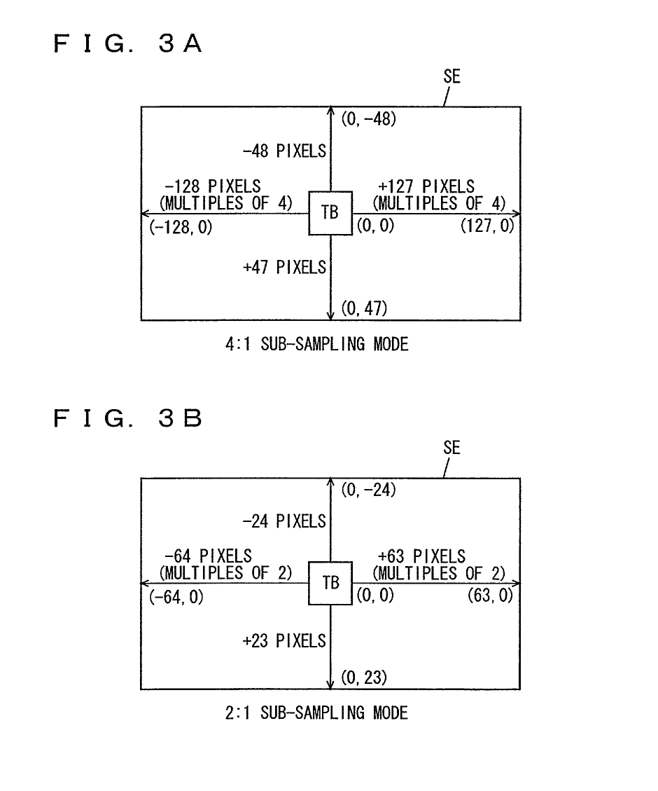

FIG. 3A schematically shows a structure of search area SE in the 4-to-1 sub-sampling mode. In the 4-to-1 sub-sampling mode shown in FIG. 3A, horizontal vector components are set in a range from −128 to +127 and vertical vector components are set in a range from −48 to +47. In the vertical direction, 96 pixels or 96 vertical vector components are present. In the horizontal direction, 252 horizontal vector components, i.e., 252 pixels (estimation points) are present. In the horizontal direction, one pixel is extracted as a representative point from each unit formed of four pixels. In FIG. 3A, “multiples of 4” depicted together with “+127 pixels” means that the estimation is effected on the vector components of multiples of 4 among the 128 horizontal vector components from 0 to +127.

FIG. 3B shows a structure of search area SE in the 2-to-1 sub-sampling mode. In the 2-to-1 sub-sampling mode, search area SE is defined by the horizontal vector components from −64 to +63 and the vertical vector components from −24 to +23. In the 2-to-1 sub-sampling mode, two pixels in the horizontal direction are sub-sampled to one pixel. Accordingly, a block having horizontal vector components of multiples of 2 is present in the range of pixels (estimation points) from 0 to +63.

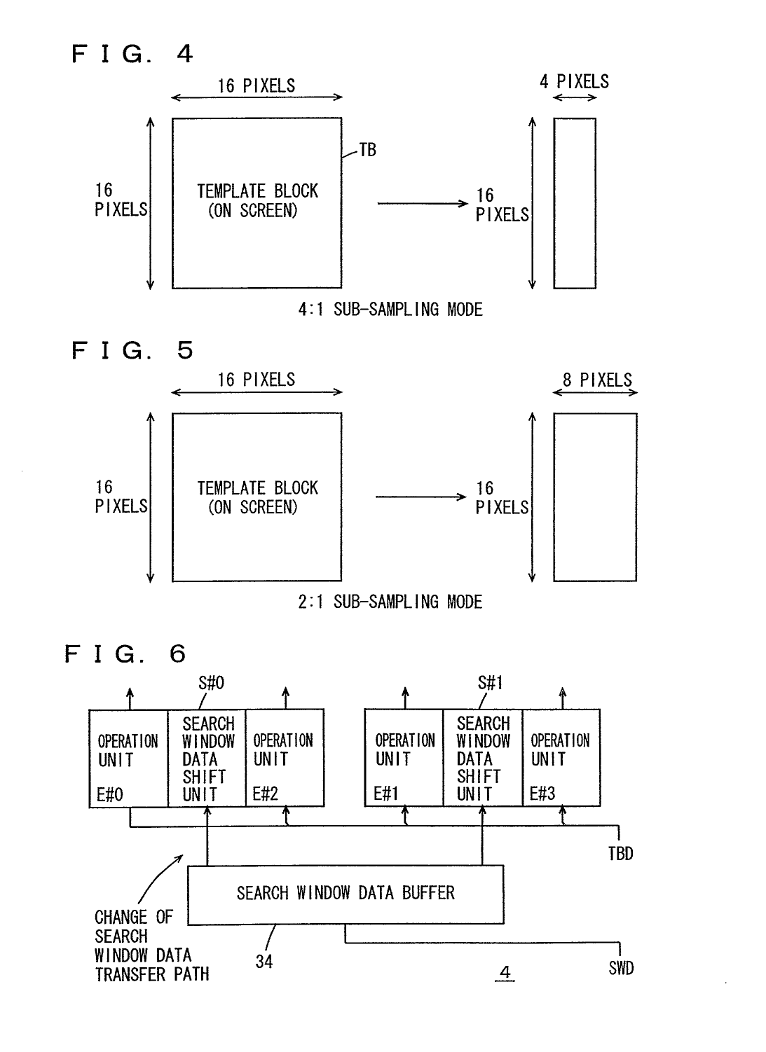

FIG. 4 shows a structure of the template block. Template block TB includes pixels arranged in 16 rows and 16 columns on the screen. In the 4-to-1 sub-sampling mode, four pixels adjacent in the horizontal direction are sub-sampled to one pixel, so that the template block is formed of the pixels in 16 rows and 4 columns.

FIG. 5 shows a structure of the template block in the 2-to-1 sub-sampling mode. In this 2-to-1 sub-sampling mode, horizontally adjacent two pixels are sub-sampled to one pixel, and thus, the template block is formed of the pixels in 16 rows and 8 columns. The motion vector detection is performed using the search window pixel data and the template block pixel data which are sub-sampled as described above.

The search areas in the 4-to-1 sub-sampling mode and in the 2-to-1 sub-sampling mode are different from each other, with the numbers of horizontal vector components being reduced to ¼ times and ½ times, respectively. Accordingly, no increase will occur in processing time even when the search areas are increased respectively by four times and two times in the horizontal direction.

Structure of Operation Section

FIG. 6 schematically shows a structure of operation section 4 shown in FIG. 1. In FIG. 6, operation section 4 includes: a plurality of operation units E#0-E#3 each of which includes a plurality of element processors arranged in rows and columns and calculates the estimation value from sub-sampled pixel data; a search window data shift unit S#0 which includes shift registers shared by operation units E#0 and E#2 and arranged corresponding to the element processors included in these operation units E#0 and E#2, and shifts the search window pixel data in one direction; a search window data shift unit S#1 which includes shift registers arranged corresponding to the element processors included in operation units E#1 and E#3, and transfers the search window pixel data in one direction; and a search window data buffer 34 which is selectively coupled to search window data shift units S#0 and S#1 in accordance with the sub-sampling rate, and stores and transfers in one direction the search window pixel data.

Each of operation units E#0-E#3 stores the corresponding pixel data in the respective element processors arranged corresponding to the representative positions (sub-sampled pixel data positions) of a plurality of pixels adjacent in the horizontal direction on the screen. Each element processor performs a prescribed arithmetic operation on the template block pixel data stored therein and the search window block pixel data supplied from the corresponding shift register. In this embodiment, each element processor obtains an absolute difference value.

Each of operation units E#0-E#3 further includes a summing section which adds the operation results of the element processors in a prescribed order to obtain a total sum, for calculation of the estimation value. As will be described later, these element processors store pixel data of a plurality of template blocks, and calculate, in a time division multiplex manner, the estimation value components indicating the degrees of correlation between the respective template blocks and a common search window block.

The element processors in operation units E#0-E#3 always store the template block pixel data during a cycle (operation cycle) for obtaining a motion vector for the relevant template block. Search window pixel data transferred through search window data buffer 34 is shifted by one pixel in search window data shift units S#0 and S#1, to shift the vertical vector component one by one. The transfer paths of the search window pixel data in search window data shift units S#0 and S#1 as well as in search window data buffer 34 are determined according to the sub-sampling rate. Search window data buffer 34 includes a delay buffer circuit that delays the applied search window pixel data by a prescribed time for outputting.

Search window data buffer 34 stores the pixel data in a side region, i.e., the region within the search window other than a search window block (i.e., the block of search window where calculation of the estimation value is being performed). By changing the transfer path through which the search window pixel data is transferred via search window data buffer 34, it becomes possible to change a range of search in the vertical direction. The change of components in the horizontal direction is allowed by changing the sub-sampling rate.

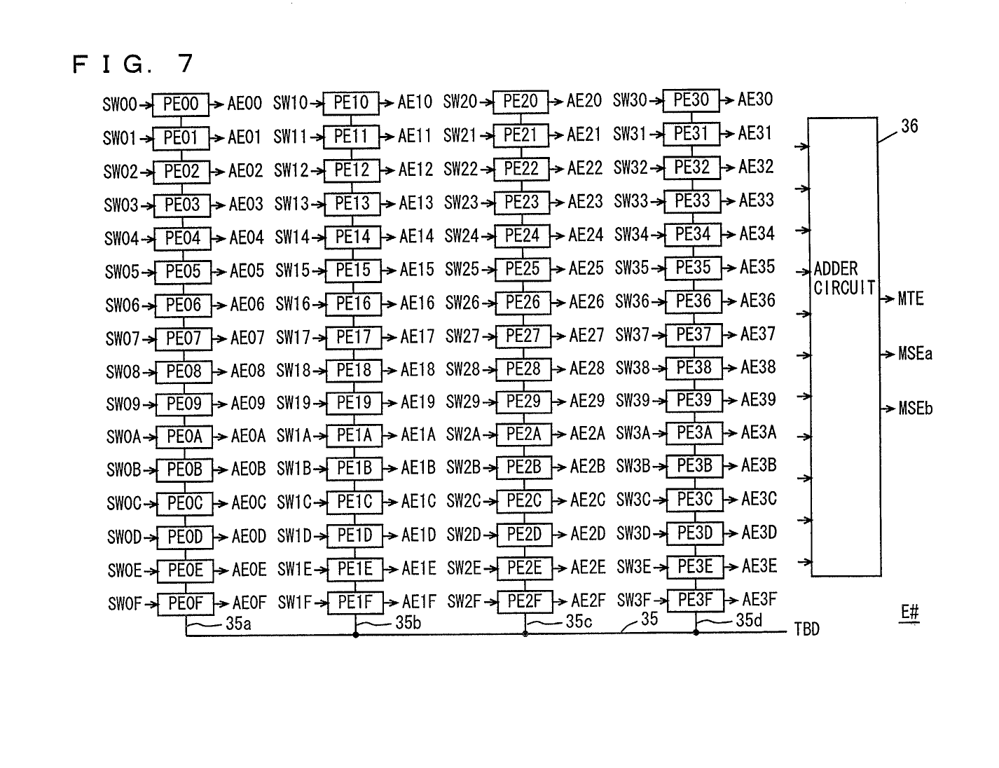

FIG. 7 shows a structure of one operation unit E# as a representative example of operation units E#0-E#3 shown in FIG. 6. In FIG. 7, operation unit E# includes element processors PE00-PE3F arranged in 16 rows and 4 columns, and an adder circuit 36 connected to receive outputs of element processors PE00-PE3F. Shift registers of the search window data shift unit are arranged corresponding to element processors PE00-PE3F. Data SW00-SW3F stored in the shift registers are applied to corresponding element processors PE00-PE3F, respectively. Template block pixel data TBD is loaded to element processors PE00-PE3F via a data bus 35. A data bus connected to this global data bus 35 is provided commonly for element processors PEi0-PEiF (i is from 0 to 3) arranged in one column. More specifically, the template block pixel data is loaded to element processors PE00-PE0F via a data bus 35a. A data bus 35b is arranged commonly for element processors PE10-PE1F for transmitting the template block pixel data thereto. Element processors PE20-PE2F receive the template block pixel data via a data bus 35c. Element processors PE30-PE3F receive the template block pixel data via a data bus 35d.

Element processors PE00-PE3F store different pixel data for the same template block. Each of element processors PE00-PE3F obtains and outputs an absolute difference value AE between the search window block pixel data applied from the shift register and the template block pixel data stored therein. Absolute difference values AE00-AE3F from element processors PE00-PE3F are applied in parallel to adder circuit 36.

Adder circuit 36 adds the received absolute difference values AE00-AE3F in a prescribed order, to produce estimation values MTE, MSEa and MSEb according to a plurality of prediction modes. Estimation value MTE represents the estimation value for all the pixel data of the template block, which is referred to as a template block mode estimation value. Estimation value MSEa is an estimation value obtained using the pixel data of a sub-template block, and estimation value MSEb is an estimation value calculated using the pixel data of the other sub-template block.

As will be described later, one template block includes two sub-template blocks. If a template block is formed of frame pixels, the template block includes even and odd field pixels. In the case where a template block is formed of field pixels, the template block can be divided into upper-half and lower-half template blocks.

In accordance with the prediction mode being actually used, the addition is performed. Addition in adder circuit 36 is executed by distributing the absolute difference values (estimation value components) AE00-AE3F received from element processors PE00-PE3F, respectively. This is because the positions where element processors PE00-PE3F are arranged correspond to the positions of representative pixels in the template block, and thus, sorting of pixel data of the upper sub-template block, lower sub-template block, even field sub-template block and odd field sub-template block is easily achieved according to the positions of the element processors. The distribution of the estimation value components in adder circuit 36 is achieved simply using interconnection lines.

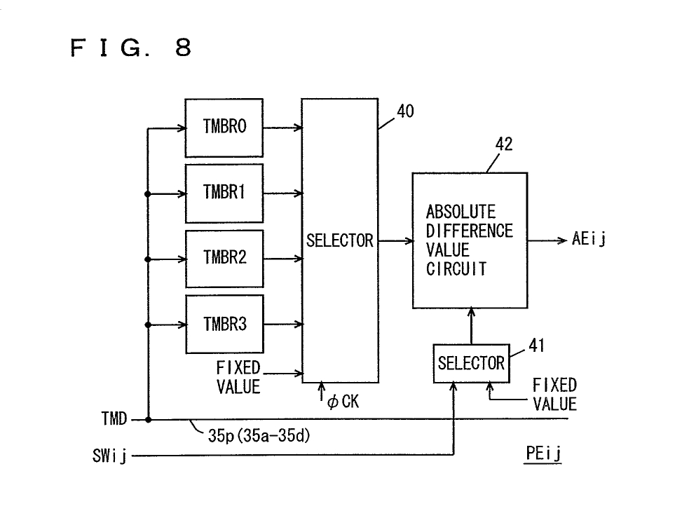

FIG. 8 schematically shows a structure of element processor PEij (i is from 0 to 3; j is from 0 to F). In FIG. 8, element processor PEij includes: data registers TMBR0-TMBR3 arranged in parallel for storing template block pixel data; a selector 40 for selecting one of data registers TMBR0-TMBR3 and a fixed value in accordance with a select signal φCK; a selector 41 for selecting one of search window block pixel data SWij and a fixed value in accordance with a select signal (not shown); and an absolute difference value circuit 42 for obtaining an absolute difference value (absolute error value) of the data applied from selectors 40 and 41.

Data registers TMBR0-TMBR3 store pixel data of different template blocks at the corresponding positions. Selector 40 successively selects these data registers TMBR0-TMBR3 in accordance with select signal φCK. Selectors 40 and 41 select and apply the fixed value to absolute difference value circuit 42 if search window block pixel data SWij received is, e.g., the pixel data outside the search area. When the fixed value is selected, the absolute difference value in absolute difference value circuit 42 is equal to zero or a minimum value, and estimation value component AEij does not contribute to the estimation value. Template block pixel data TMD is supplied via data bus 35b (35a-35d) to data registers TMBR0-TMBR3. An addressed data register stores template block pixel data TMD.

A scanning test is unnecessary for data registers TMBR0-TMBR3, and therefore, a D latch circuit simply holding 1-bit data can be employed as each of them.

Structure of Shift Unit

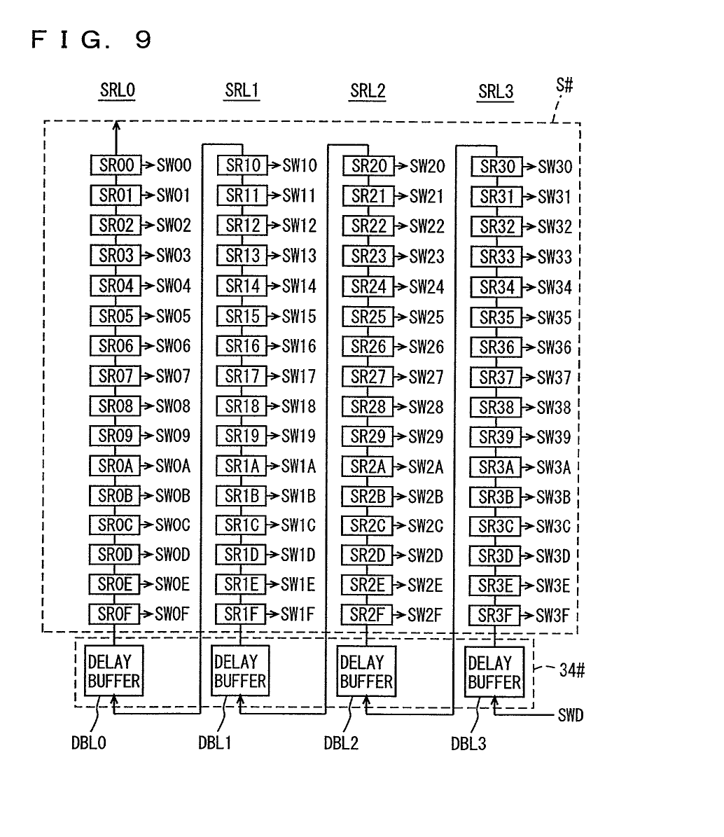

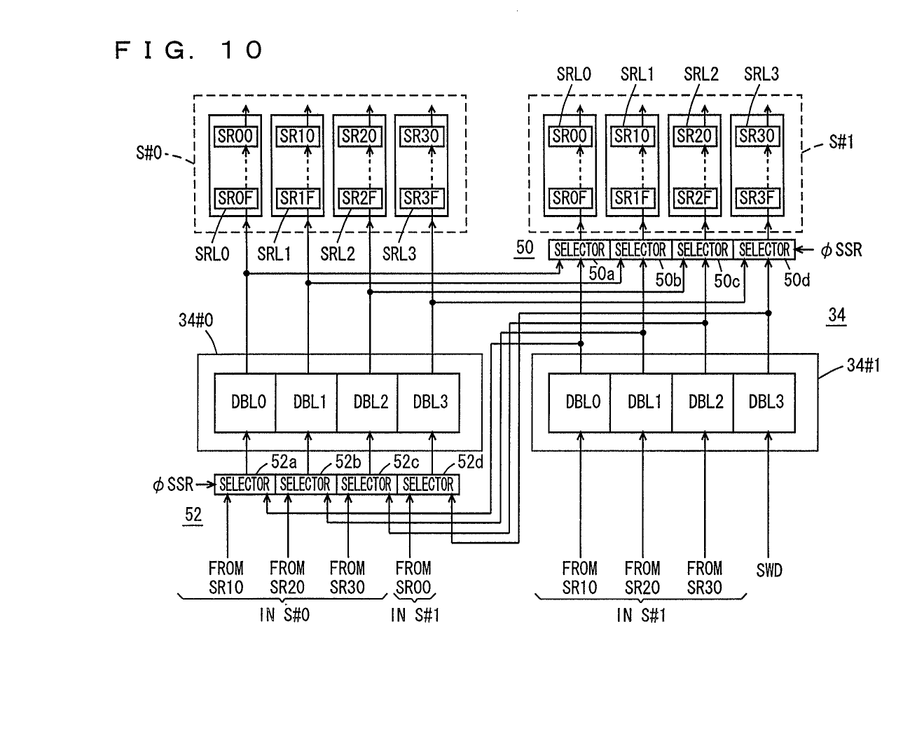

FIG. 9 shows structures of the search window data shift unit and the search window data buffer shown in FIG. 6. In FIG. 9, the structure of one search window data shift unit S# is shown representatively. Referring to FIG. 9, search window data shift unit S# includes shift registers SR00-SR3F arranged in rows and columns corresponding to element processors PE00-PE3F of operation unit E# shown in FIG. 7. Accordingly, shift registers SR00-SR3F are arranged in 16 rows and 4 columns. Data SW00-SW3F stored in shift registers SR00-SR3F are applied to respective element processors PE00-PE3F of the corresponding operation unit. Shift registers SR00-SR3F can transfer the search window pixel data in one direction.

Search window data buffer 34 includes a data buffer circuit 34# provided corresponding to search window data shift unit S#. Data buffer circuit 34# is provided for each of search window data shift units S#0 and S#1. Data buffer circuit 34# includes delay buffers DBL0-DBL3 provided corresponding to respective shift register columns SRL0-SRL3 of search window data shift unit S#. Delay buffers DBL0-DBL3 have first-in first-out (FIFO) structures and successively delay the applied search window pixel data by a prescribed time for outputting.

In FIG. 9, shift registers SR00-SR3F included in search window data shift unit S# are connected to delay buffers DBL0-DBL3 such that the pixel data can be transferred in one direction. More specifically, the output pixel data of shift register SR30 at the final stage in shift register column SRL3 is applied to delay buffer DBL2 in the next stage. The output pixel data of shift register SR20 at the final stage in shift register column SRL2 is applied to delay buffer DBL1 in the next stage. The output pixel data of shift register SR11 at the final stage in shift register column SRL1 is applied to delay buffer DBL0. The output pixel data of delay buffers DBL0-DBL3 are applied to respective shift registers SR0F-SR3F in the initial stages of corresponding shift register columns SRL0-SRL3. Delay buffer DBL3 receives search window pixel data SWD from the search window data memory in input section 2. In an operation cycle, data of one pixel is shifted at every clock cycle. Pixel data of a template block are resident in the element processors of the operation unit, and search window pixel data is shifted by one pixel in the search window data shift unit. This shift by one pixel moves the search window block by one pixel in the vertical direction. This operation will be described below in detail.

The connection paths between shift register columns SRL0-SRL3 in search window data shift unit S# and delay buffers DBL0-DBL3 in search window data buffer 34# shown in FIG. 9 are changed according to the sub-sampling rate.

FIG. 10 shows a more specific structure of search window data buffer 34. Referring to FIG. 10, search window data buffer 34 includes: data buffer circuits 34#0 and 34#1 provided corresponding to search window data shift units S#0 and S#1, respectively; a select circuit 50 for selecting output pixel data of one of data buffer circuits 34#0 and 34#1 in accordance with a sub-sampling rate designating signal φSSR, for transmission to search window data shift unit S#1; and a select circuit 52 for selecting one of the output data of data buffer circuit 34#1 and the output pixel data of shift units S#0 and S#1 in accordance with sub-sampling rate designating signal φSSR, for transmission to data buffer circuit 34#0. The select paths are changed in these select circuits 50 and 52 in accordance with sub-sampling rate designating signal φSSR, whereby the transfer path of the search window pixel data in the operation section is changed, and correspondingly, the size of the search window block is changed in accordance with the sub-sampling rate.

Each of data buffer circuits 34#0 and 34#1 includes delay buffers DBL0-DBL3. Each of delay buffers DBL0-DBL3 is formed of, e.g., a FIFO memory of 48 words. One word corresponds to one pixel data.

Select circuit 50 includes selectors 50a-50d provided corresponding to respective shift register columns SRL0-SRL3 in search window data shift unit S#1. Selector 50a selects one of the output data of respective delay buffers DBL0 of data buffers 34#0 and 34#1, for application to shift register SR0F in the initial stage of shift register column SRL0 of shift unit S#1. Selector 50b selects one of the output data of delay buffers DBL1 of data buffers 34#0 and 34#1 for application to shift register SR1F in the initial stage of shift register column SRL1 in shift unit S#1. Selector 50c selects one of the output data of delay buffers DBL2 of data buffers 34#0 and 34#1 for application to shift register SR2F in the initial stage of shift register column SRL2 in shift unit S#1. Selector 50d selects one of the output data of delay buffers DBL3 of data buffers 34#0 and 34#1 for application to shift register SR3F in the initial stage of shift register column SRL3 in shift unit S#1.

Select circuit 52 includes selectors 52a-52d provided corresponding to respective delay buffers DBL0-DBL3 of data buffer circuit 34#0. Selector 52a selects one of the output data of shift register SR10 at the final stage in preceding shift register column SRL1 located in shift unit S#0 and the output data of delay buffer DBL0 of data buffer circuit 34#1, for application to delay buffer DBL0 of data buffer circuit 34#0. Selector 52b selects one of the output data of shift register SR20 at the final stage in preceding shift register column SRL2 in shift unit S#0 and the output data of delay buffer DBL1 of data buffer circuit 34#1 for application to delay buffer DBL1 of data buffer circuit 34#0. Selector 52c selects one of the output data of shift register SR30 at the final stage in preceding shift register column SRL3 in shift unit S#0 and the output data of delay buffer DBL2 of data buffer circuit 34#1 for application to delay buffer DBL2 of data buffer circuit 34#0. Selector 52d selects one of the output data of shift register SR00 at the final stage of the final shift register column SRL0 of shift unit S#1 and the output data of delay buffer DBL3 of data buffer circuit 34#1 for application to delay buffer DBL3 of data buffer circuit 34#0.

The output pixel data of delay buffers DBL0-DBL3 of data buffer circuit 34#0 are also applied to respective shift registers SR0F-SR3F at the initial stages of the corresponding shift register columns in shift unit S#0.

In data buffer circuit 34#1, delay buffers DBL0-DBL2 receive output pixel data of shift registers SR10, SR20 and SR30, respectively, at the final stages of the preceding shift register columns of shift unit S#1. Delay buffer DBL3 of data buffer circuit 34#1 is supplied with search window pixel data SWD from the pixel data input section.

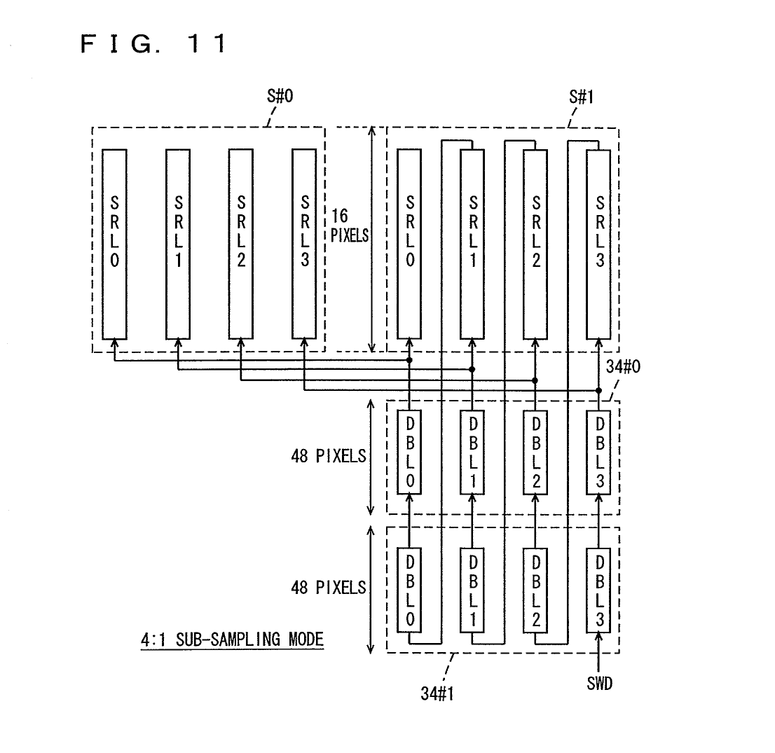

FIG. 11 schematically shows connection paths between the data buffers and the shift units in the 4-to-1 sub-sampling mode. In the 4-to-1 sub-sampling mode shown in FIG. 11, select circuit 50 selects and applies output pixel data of data buffer circuit 34#0 to shift unit S#1. Select circuit 52 selects and applies output pixel data of data buffer circuit 34#1 to data buffer circuit 34#0. Thus, in data buffer circuits 34#0 and 34#1, the delay buffers arranged in the same columns are connected in series, as shown in FIG. 11. The output pixel data of delay buffers DBL0-DBL3 of data buffer circuit 34#0 are applied in parallel to respective shift register columns SRL0-SRL3 in each of shift units S#0 and S#1. Therefore, shift units S#0 and S#1 receive the same search window pixel data.

Each of shift units S#0 and S#1 is shared by two operation units. The sub-sampled template block has a size of 16 pixel rows by 4 pixel columns. In data buffer circuits 34#0 and 34#1, each of delay buffers DBL0-DBL3 stores data of 48 pixels, and therefore, each column extending in data buffer circuits 34#0 and 34#1 stores data of 96 pixels. Shift unit S#1 as well as data buffer circuits 34#0 and 34#1 transfer search window pixel data SWD in one direction. This is because delay buffers DBL0-DBL2 in data buffer circuit 34#1 receive the output pixel data of preceding shift register columns SRL1-SRL3, respectively.

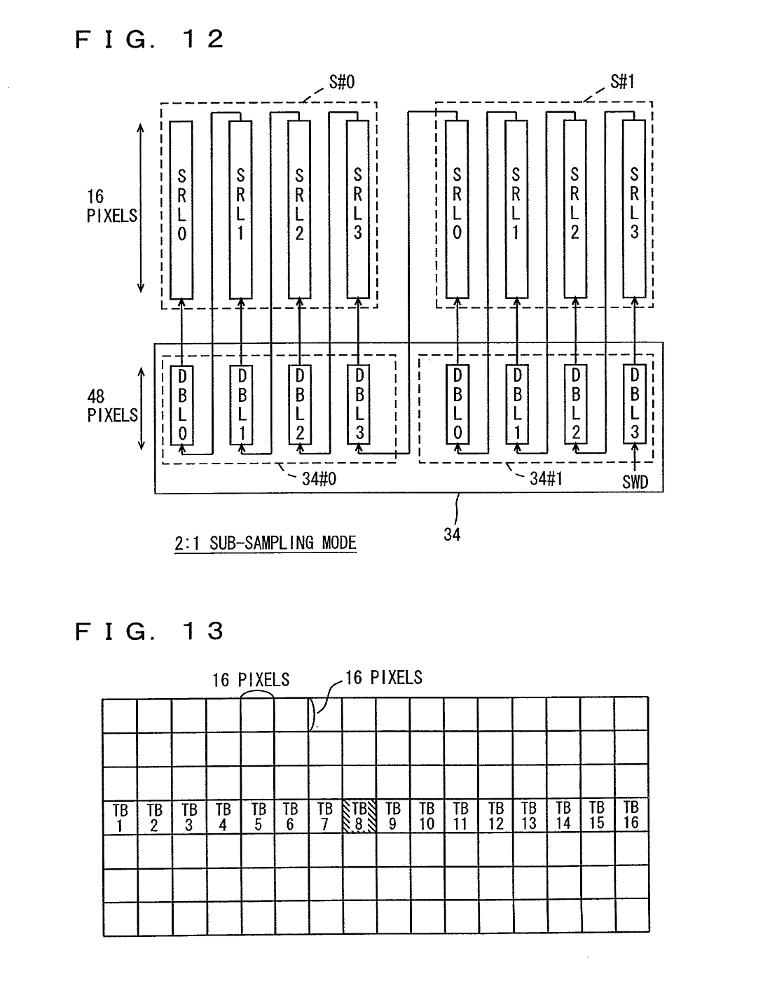

FIG. 12 schematically shows connection of the search window data buffer circuits and the shift units in the 2-to-1 sub-sampling mode. In the 2-to-1 sub-sampling mode, select circuit 50 shown in FIG. 10 selects and applies the output pixel data of data buffer circuit 34#1 to shift unit S#1. Select circuit 52 selects the output data of the final column SR0 in shift unit S#1 and the output data of upstream columns SRL1-SRL3 in shift unit S#0 for application to shift unit S#0. Thus, in this 2-to-1 sub-sampling mode, data buffer circuit 34#1, shift unit S#1, data buffer circuit 34#0 and shift unit S#0 are connected such that search window pixel data SWD is transferred in one direction along a meandering path. More specifically, shift registers SRL0-SRL3 transfer the search window pixel data in one direction through delay buffers DBL0-DBL3 provided in the succeeding stages thereof.

With the connection shown in FIG. 12, the search window block is formed of pixels arranged in 16 rows and 8 columns (because pixel data of the same search window block are stored and shifted in shift units S#0 and S#1). Data buffer circuits 34#0 and 34#1 have the delay buffers each interposed between the shift register columns. Delay buffers DBL0-DBL3 each store data of 48 pixels. Therefore, the search area is defined between −24 and +23 in the vertical direction. Description will now be given on the motion vector detecting operation in each sub-sampling mode.

Operation in 4-to-1 Sub-Sampling Mode

It is now assumed that a frame image is divided into macro blocks each having a size of 16 pixels by 16 pixels, as shown in FIG. 13. FIG. 13 shows an example where 16 divided blocks are present in the horizontal direction and 7 blocks in the vertical direction. This whole region corresponds to the search area for macro block TB8. Here, this macro block TB8 is regarded as the block to be coded, or, the template block.

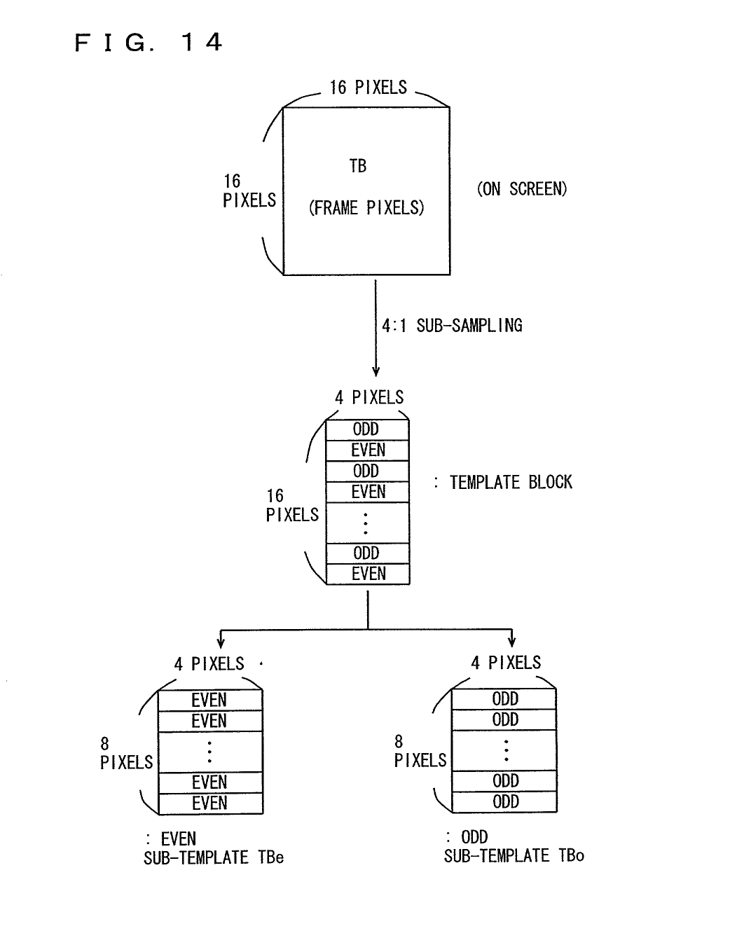

As shown in FIG. 14, template block TB on the screen has a size of 16 pixels by 16 pixels. Template block TB is formed of frame pixels, and includes pixel data in the even field and the odd field.

When input section 2 performs the 4-to-1 sub-sampling, 16 pixels in the horizontal direction are sub-sampled to 4 pixels. Therefore, the template block stored in the operation section forms a sub-sampled template block of 4 pixels in the horizontal direction and 16 pixels in the vertical direction. In this sub-sampled template block, pixel data of odd field ODD and pixel data of even field EVEN are arranged alternately in the vertical direction. Of the sub-sampled template block, an even sub-template formed of pixels in the even fields EVEN includes pixels arranged in 8 rows and 4 columns. Likewise, an odd sub-template formed of pixels in odd fields ODD is formed of pixels in 8 rows and 4 columns. The motion vector detection is performed in parallel on the template block, even sub-template block TBe and odd sub-template block TBo.

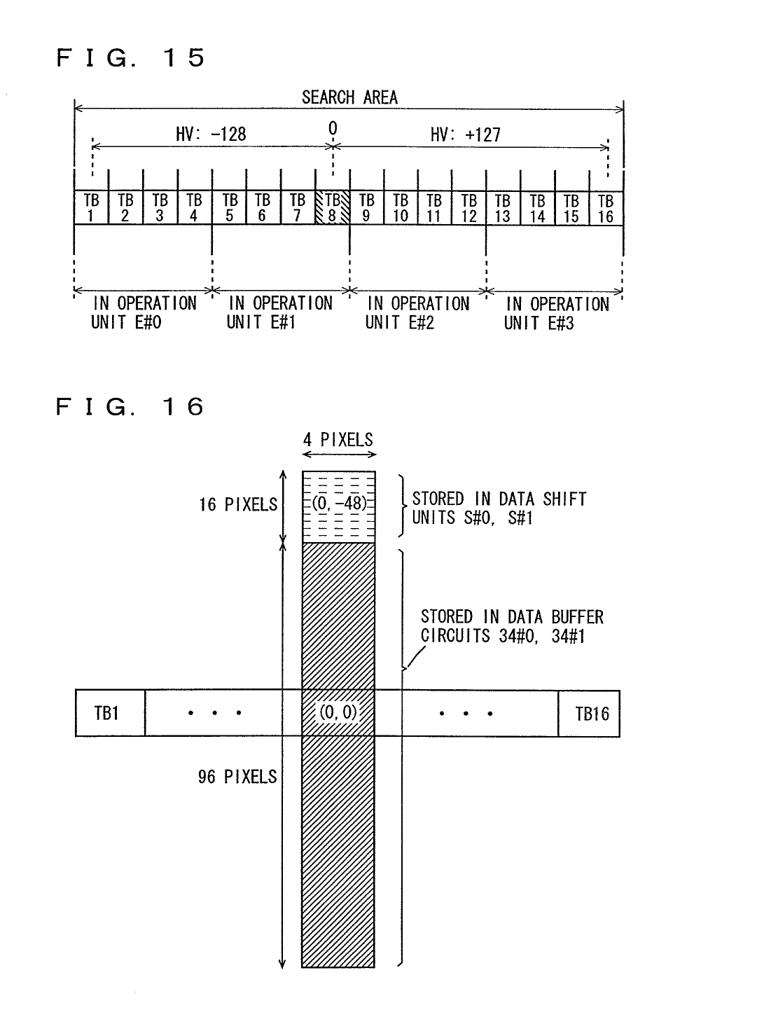

In the case of 4-to-1 sub-sampling, as shown in FIG. 15, the motion vector is searched in the area of horizontal vector components between −128 and +127. In connection with template block TB8, template blocks TB1-TB16 aligned in the horizontal direction are included in this search area. The motion vector detection is performed for these 16 template blocks TB1-TB16 in a pipeline manner. Operation unit E#0 stores the pixel data of template blocks TB1-TB4, and operation unit E#1 stores the pixel data of template blocks TB5-TB8. Operation unit E#2 stores the pixel data of template blocks TB9-TB12, and operation unit E#3 stores the pixel data of template blocks TB13-TB16. The pixel data of the four template blocks are stored in four template block data registers TMBR0-TMBR3 (R0-R3), respectively, in each element processor, as shown in FIG. 8.

In the case of 4-to-1 sub-sampling, data buffer circuits 34#0 and 34#1 are connected in series and store data of 96 pixels in the vertical direction. Shift units S#0 and S#1 are supplied with the same search window pixel data. Each of shift units S#0 and S#1 contains shift registers arranged in 16 rows and 4 columns. These shift registers store the search window pixel data.

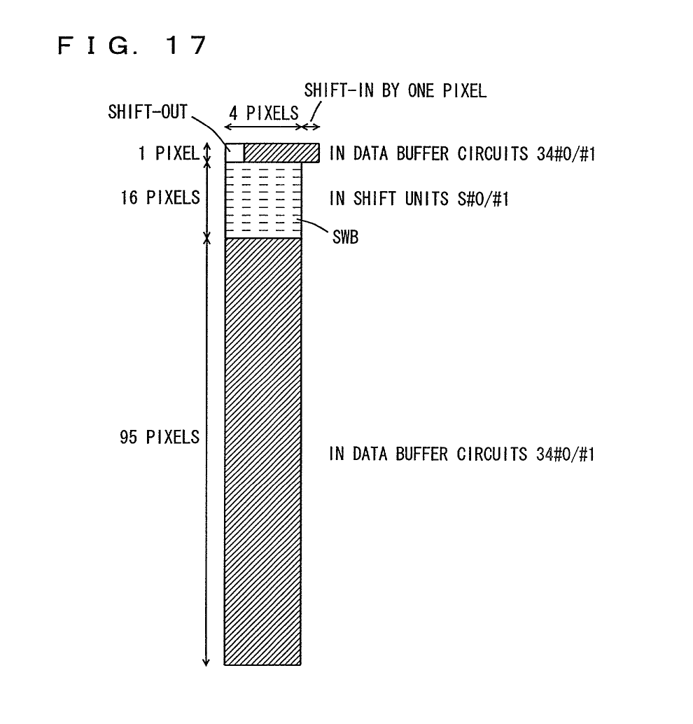

FIG. 16 shows a state of storage of the search window data in the operation section at a certain time point. In FIG. 16, a displacement of a search window block right behind the template block TB8 is represented as (0, 0). Data shift units S#0 and S#1 store pixel data of a search window block of a displacement vector (0, −48). Search window pixel data of 96 rows and 4 columns is stored in data buffer circuits 34#0 and 34#1. Template blocks TB1-TB16 have different diplacement vectors with respect to the search window block, and estimation values with respect to these template blocks TB1-TB16 are calculated.

The estimation value calculation on template blocks TB1-TB16 shown in FIG. 16 is executed in a time division multiplex manner by respective operation units E#0-E#3. Each of template blocks TB1-TB16 corresponds to 16 pixels in the horizontal direction on the screen, and is displaced by 16 pixels from the adjacent block in the horizontal direction.

In this arithmetic operation, the search window pixel data is applied from the shift unit to each element processor for a period of 4 clock cycles. Operation units E#0-E#3 each calculate the estimation values of four different template blocks in the respective clock cycles.

When the estimation value calculating cycle for one search window block is completed, the search window pixel data is transferred by one pixel, with the template block pixel data being held in each element processor PE. More specifically, input section 2 applies search window pixel data by one pixel, and the shift units and the data buffer circuits 34#0 and 34#1 execute the data transfer by one pixel. Shift unit S#0 stores the same search window pixel data as shift unit S#1. Shift unit S#1 and data buffer circuits 34#0 and 34#1 are provided with a continuous data transfer path, so that the data transfer by one pixel is simultaneously executed in shift units S#0 and S#1 as well as in data buffer circuits 34#0 and 34#1.

Data buffer circuit 34#0 transfers the image data to corresponding shift register columns SRL0-SRL3. Thus, in the search window block shown in FIG. 16, the pixels in the uppermost row are transferred by the transfer operation into data buffer circuit 34#1, while data of one pixel row are transferred from data buffer circuit 34#0 to shift units S#0 and S#1.

FIG. 17 shows the stored state of the search window data when the aforementioned data transfer by one pixel is performed. The search window data held in the shift register SR00 at the final stage in the uppermost column (last column) SRL0 is shifted out, and one-pixel data is shifted into the data buffer circuit. Therefore, data buffer circuits 34#0 and 34#1 hold the search window pixel data of 96 pixels by 4 pixels. Shift units S#0 and S#1 store the pixel data of search window block SWB shifted vertically by one pixel. In this state, operation units E#0-E#3 each calculate the estimation values.

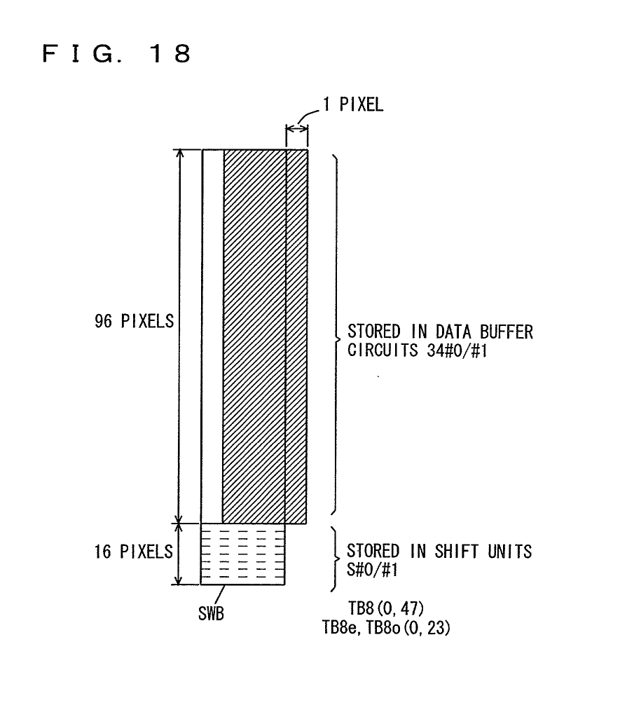

This search window pixel data transferring operation is repeated by the number of times of the vertical displacements (i.e., 96 from −48 to +47) with respect to one horizontal displacement. In this state, as shown in FIG. 18, the search window block at the lowermost position among the search window blocks is stored in shift units S#0 and S#1. In data buffer circuits 34#0 and 34#1, search window pixel data (of 96 pixels) for the next horizontal vector component is newly shifted in, and the pixel data no longer necessary is shifted out.

In the state shown in FIG. 18, the frame displacement vector of (0, 47) is allocated to template block TB8, and even and odd sub-template blocks TB8e and TB8o are allocated with field displacement vectors of (0, +23) with respect to the even and odd fields, respectively. In this state, the estimation value calculation is executed, and thus, the vector searching operation for one horizontal displacement component is completed. When this searching operation is completed, the transfer of search window pixel data is performed for 16 cycles such that 16 pixels of search window pixel data are input into the data buffer circuit. During this 16-cycle transfer operation, the estimation value calculation is not executed.

FIG. 19 schematically shows the state of storage of the search window pixel data after the 16 pixels are shifted in. By the shift-in of the 16 pixels, as shown in FIG. 19, search window pixel data corresponding to the next horizontal vector component (incremented by +4) is stored in the operation units. The shift registers of shift units S#0 and S#1 store the pixel data of the search window block of displacement vector (+4, −48) with respect to template block TB8. The remaining pixel data is stored in data buffer circuits 34#0 and 34#1. Thus, by repeating the same processing after the shift-in of the 16-pixel data, the motion vector can be searched in the search window having its horizontal vector component incremented by +4. Thereafter, the same operation is executed for each displacement vector in the search area.

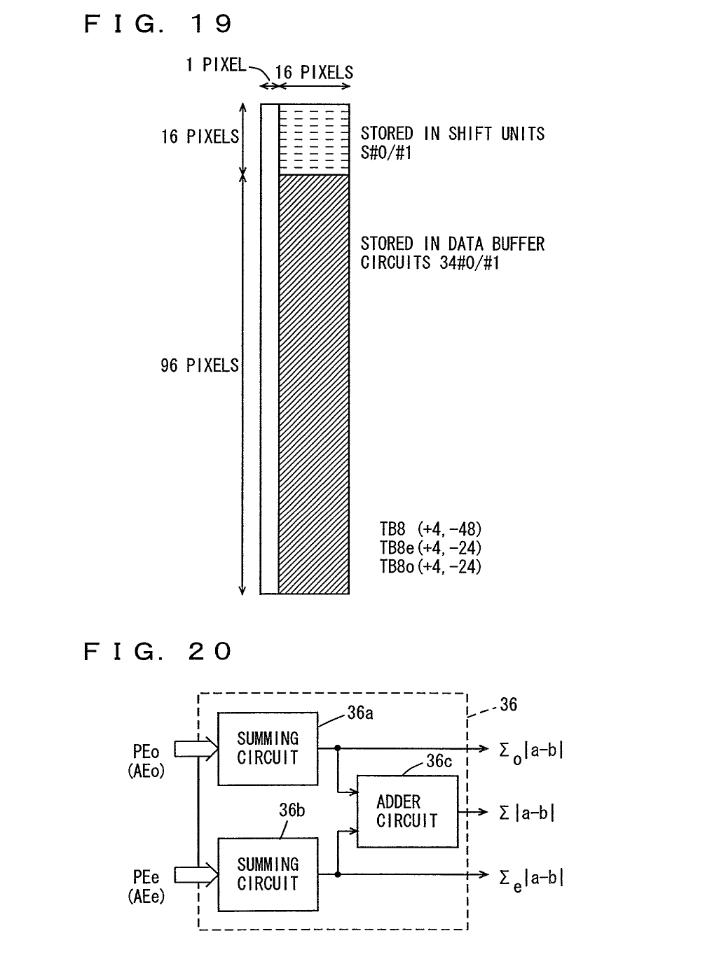

FIG. 20 schematically shows a structure of adder circuit 36 shown in FIG. 7. As shown in FIG. 7, element processors PEij are arranged corresponding to the respective pixels in the template block. Accordingly, it is possible to determine whether each element processor is arranged corresponding to a pixel in even field EVEN or that in odd field ODD from the position of the relevant processor. Adder circuit 36 utilizes this feature to calculate estimation values in three prediction modes as follows.

In FIG. 20, adder circuit 36 includes: a summing circuit 36a for obtaining a total sum of output data (estimation value components) PEo (AEo) of the element processors arranged corresponding to the pixels in the odd field; a summing circuit 36b for obtaining a total sum of output data (absolute difference values AEe) PEe of the element processors arranged corresponding to the pixels in even field EVEN; and an adder circuit 36c for obtaining a sum of the output values of summing circuits 36a and 36b. Summing circuit 36a generates a motion vector estimation value Σₒ|a−b| related to the odd sub-template block, and summing circuit 36b generates a motion vector estimation value Σₑ|a−b| related to the even sub-template block. Adder circuit 36c generates an estimation value Σ|a−b| for the template block. Accordingly, the estimation values according to the three prediction modes of frame prediction, even field prediction and odd field prediction can be derived in parallel.

Element processor PE stores pixel data of four template blocks. The estimation values of these four template blocks are calculated in a time division multiplex manner. Therefore, the motion vector estimation values for the four template blocks are calculated in four clock cycles. The search window pixel data is transferred every four clock cycles.

According to the screen division shown in FIG. 13, the region including 16 template blocks TB1-TB16 aligned in the horizontal direction is assumed as the search area. It is not essential that the horizontal size of this search area is equal to the horizontal size of one screen. The screen may be divided into 32 portions in the horizontal direction, and the motion vector detection may be performed for 16 template blocks.

When all the motion vector estimation values are calculated in the search area, the displacement vector for the template block giving a minimum estimation value, stored in comparison section 6 shown in FIG. 1, is determined as the motion vector for each of the prediction modes. Comparison section 6 is simply formed of a register and a comparator, and is configured to compare an applied estimation value with the estimation value stored in the register, update the content of the register upon each application of a smaller estimation value, and store the corresponding displacement vector value. The displacement vector of a motion vector candidate may be updated in accordance with a predetermined priority when the same estimation value components are applied.

In the 4-to-1 sub-sampling data, the pixels are sub-sampled at a rate of 4:1 in the horizontal direction, and therefore, the number of estimation values to be calculated would not change even when the horizontal vector components are increased by four times. This enables the motion vector search in a wider search area. In addition, the motion vector calculation is performed in parallel for a plurality of template blocks, whereby high-speed motion vector detection is enabled.

Operation in 2-to-1 Sub-Sampling Mode

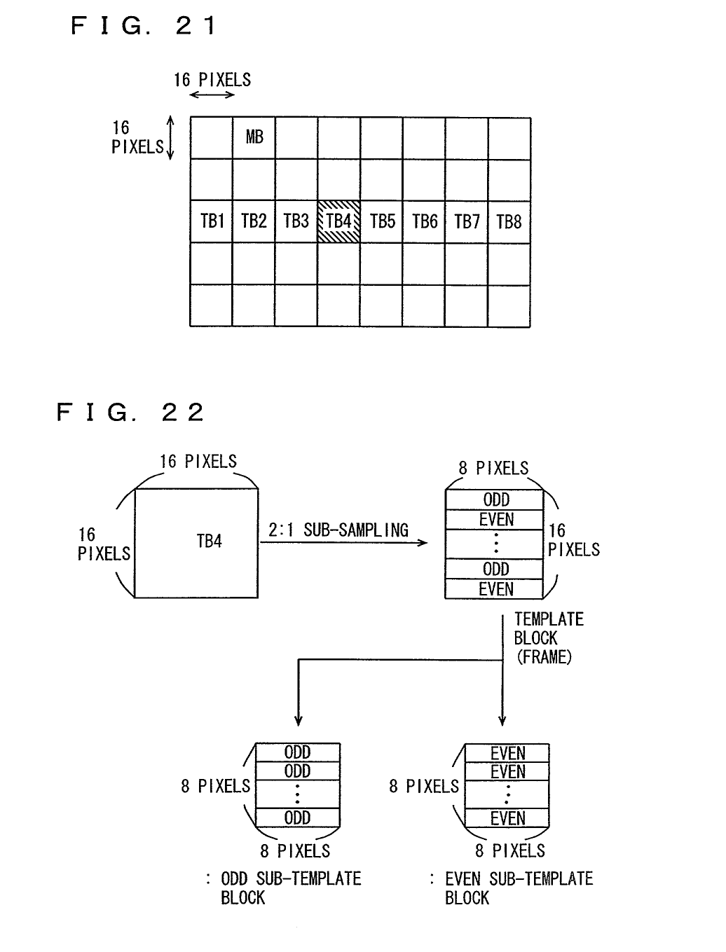

In the 2-to-1 sub-sampling mode, shift units S#0 and S#1 as well as data buffer circuits 34#0 and 34#1 are connected by select circuits 50 and 52 such that the pixel data is continuously transferred in one direction, as shown in FIG. 12. More specifically, shift units S#0 and S#1 store the search window pixel data displaced by the delay times of delay buffers DBL0-DBL3. It is now assumed that one frame image is divided into eight macro blocks in the horizontal direction, as shown in FIG. 21. The whole region corresponds to a search area for template block TB4. Each macro block is formed of 16 pixels by 16 pixels.

FIG. 22 schematically shows a structure of the template block processed by the operation section in the 2-to-1 sub-sampling mode. In the 2-to-1 sub-sampling mode, horizontally adjacent two pixels are sub-sampled into one pixel. Accordingly, template block TB4 of 16 pixels by 16 pixels is reduced into a frame template block of 16 pixel rows by 8 pixel columns. This frame template block includes pixel data of both even field EVEN and odd field ODD. The odd sub-template block is formed of 8 pixel rows by 8 pixel columns, and the even sub-template block is likewise formed of 8 pixel rows and 8 pixel columns.

Description will now be given on the motion vector detection for template block TB4.

FIG. 23 schematically shows an arrangement of the operation section. Referring to FIG. 23, shift unit S#0 and data buffer circuit 34#0 form a sub-shift block SSB0 that transfers 4 pixel columns. Shift unit S#1 and data buffer circuit 34#1 form a sub-shift block SSB1 that transfers the search window pixel data of four columns. The pixel data shifted out from shift unit S#1 is applied to data buffer circuit 34#0. Operation unit E#0 stores the pixel data of the left halves of respective template blocks TB1-TB4, and operation unit E#1 stores the pixel data of the right halves of respective template blocks TB1-TB4. Operation unit E#2 stores the pixel data of the left halves of respective template blocks TB5-TB8, and operation unit E#3 stores the pixel data of the right halves of respective template blocks TB5-TB8. Each of data buffer circuits 34#0 and 34#1 stores search window pixel data of 48 pixels in the horizontal direction. In the 2-to-1 sub-sampling mode, the vertical search range is between −24 and +23. Therefore, shift units S#0 and S#1 store the search window pixel data in the same positions in the vertical direction.

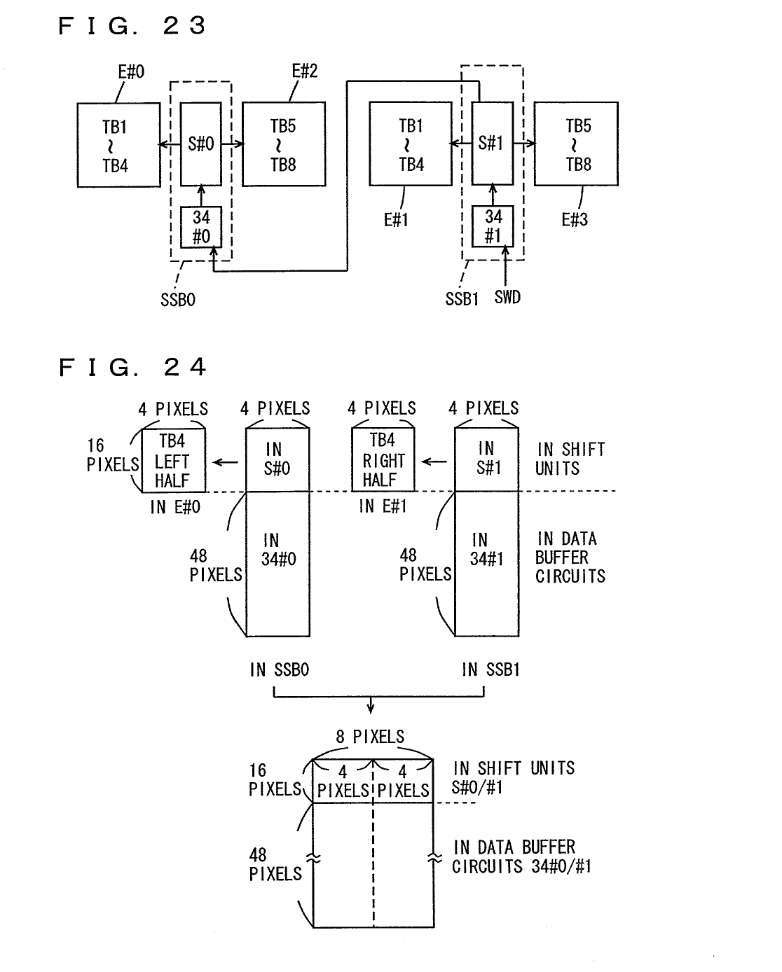

FIG. 24 shows the stored state of the pixel data with respect to template block TB4. Operation unit E#0 stores the pixel data of the left half of template block TB4 of 16 pixel rows by 4 pixel columns. Operation unit E#1 stores the pixel data of the right half of template block TB4 of 16 rows by 4 columns. Shift unit S#0 stores the search window pixel data of 16 pixel rows by 4 pixel columns, and data buffer circuit 34#0 stores the search window pixel data of 48 pixel rows by 4 pixel columns.

Shift unit S#1 stores the search window pixel data of 16 pixel rows by 4 pixel columns, and data buffer circuit 34#1 stores the search window pixel data of 48 pixel rows by 4 pixel columns. By combining the pixel data stored in sub-shift blocks SSB0 and SSB1, shift units S#0 and S#1 store the search window block pixel data of 16 pixel rows by 8 pixel columns, and data buffer circuits 34#0 and 34#1 store the search window pixel data of 48 pixel rows by 8 pixel columns, as shown in FIG. 24. Accordingly, operation unit E#0 produces the estimation value components for the pixel data of the left half of template block TB4, and operation unit E#1 calculates the estimation value components for the pixel data of the right half of template block TB4. The estimation value of template block TB4 is generated by summing up these estimation value components.

As can be seen from FIG. 24, the shift operation of search window pixel data in the 2-to-1 sub-sampling mode is performed, as in the 4-to-1 sub-sampling mode, by shifting in the data pixel by pixel and shifting the data pixel by pixel in sub-shift blocks SSB0 and SSB1.

In the stored state of the search window pixel data in sub-shift blocks SSB0 and SSB1 shown in FIG. 24, the displacement vector of (0, −24) is allocated to frame template block TB4. Odd sub-template block TB4o is allocated with field displacement vector (0, −12) with respect to odd field ODD. Even sub-template block TB4e is allocated with field displacement vector (0, −12) with respect to even field EVEN. With respect to these displacement vectors, respective element processors PEij obtain absolute difference values between the search window pixel data SWij received from corresponding shift registers SRij in the shift unit and the template block pixel data stored. The resultant absolute difference values are summed up in summing section 36. More specifically, the total sum of the absolute difference values for odd sub-template block TB4o and the total sum of the absolute difference values for even sub-template block TB4e are obtained independently of each other. Thereafter, these total sums are added up to obtain the total sum of absolute difference values for template block TB4. The total sums of the absolute difference values generated by operation units E#0-E#3 each correspond to the sum of absolute difference values for half the pixel data of the template blocks. Therefore, another summing circuit is employed to add up the total sums of the absolute difference values of displacement vectors output from the respective operation units. The estimation values with respect to template block TB4 are thus produced according to the three prediction modes of frame prediction, even field prediction and odd field prediction.

Element processor PEij stores pixel data of four template blocks. This is the same as in the 4-to-1 sub-sampling mode described above. Therefore, the search window pixel data is held in the shift registers for a period of four clock cycles such that the estimation value components for the respective template blocks are calculated. After a lapse of the four clock cycles, the search window pixel data is shifted by one pixel.

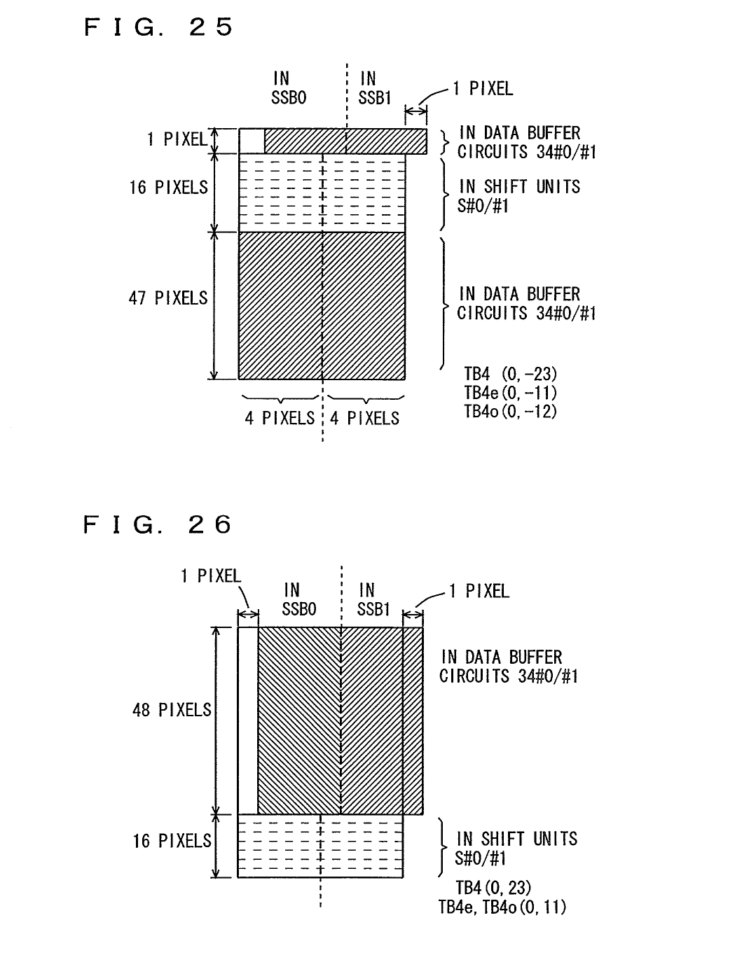

FIG. 25 schematically shows the stored state of the search window pixel data in sub-shift blocks SSB0 and SSB1 after the shift of one pixel. Referring to FIG. 25, search window data of one pixel is shifted into data buffer circuit 34#. Correspondingly, the shift operation of one pixel is performed in sub-shift blocks SSB1 and SSB0, and the pixel data shifted out of shift unit S#1 is shifted into data buffer circuit 34#0. Also, data of one pixel is shifted out of shift unit S#0. Sub-shift block SSB0 stores four pixels in the uppermost row in the FIG. 25 as well as lower 47 by 4 pixels. Shift unit S#0 stores the search window block pixel data of 16 pixels by 4 pixels. Sub-shift block SSB1 stores the search window pixel data of four pixels in the uppermost row in FIG. 25 as well as lower 47 by 4 pixels. Shift unit S#1 stores the search window block pixel data of 16 pixels by 4 pixels.

This state corresponds to the state where shift units S#0 and S#1 store, with respect to frame template block TB4, the search window blocks having the frame displacement vector (0, −23) for the template block, the field displacement vector (0, −12) with respect to even field EVEN for odd sub-template block TB4o, and the field displacement vector (0, −11) with respect to odd field ODD for even sub-template block TB4e. The processing for obtaining the absolute difference values and the total sums thereof are performed on the search window block stored in shift units S#0 and S#1, as in the foregoing case. The estimation values are thus calculated according to the respective prediction modes of frame prediction, even field prediction and odd field prediction.

The above-described operation of transferring search window pixel data is repeated by the number of times of the vertical displacements (i.e., 48 between −24 and +23) with respect to one horizontal displacement. Accordingly, the search window block moves to the lowermost position, as shown in FIG. 26. This state corresponds to the state where the search window block having the frame displacement vector (0, 23) for template block TB4, the field displacement vector (0, 11) with respect to the even field for even sub-template block TB4e, and the field displacement vector (0, 11) with respect to the odd field for odd sub-template block TB4o is stored. The data buffer circuit has already stored the search window pixel data of 48 pixels. In this state, calculation of the estimation values is performed. Data buffer circuits 34#0 and 34#1 store the search window pixel data stored in shift units S#0 and S#1 as well as the search window pixel data of pixels in the positions shifted horizontally by one sub-sampled pixel.

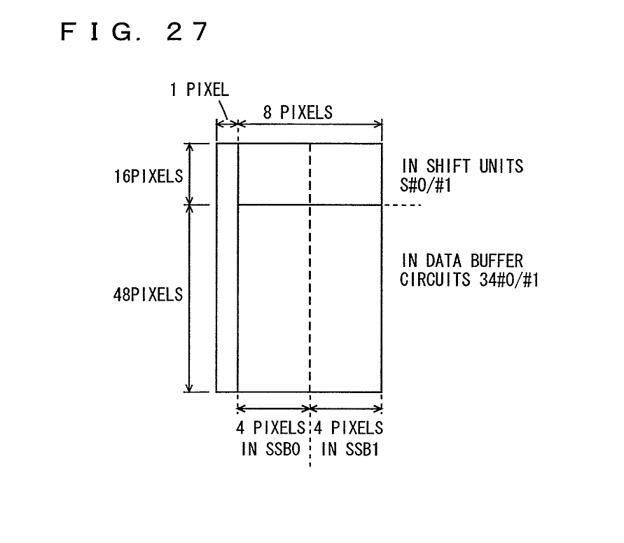

After completion of the arithmetic operation, solely the operation of transferring the search window pixel data, not accompanied by the arithmetic operation, is repeated 16 times (for 16 clock cycles). As a result, a state as shown in FIG. 27 is achieved which allows the estimation with respect to the next horizontal displacement vector (incremented by +2) for the initial vertical displacement point.

Specifically, the operation section stores the pixel data of the search window horizontally shifted by one sub-sampled pixel data, which in this case corresponds to two pixels on the screen. The estimation value calculating operation is executed for every vector in the search area.

From the resultant estimation values, comparison section 6 obtains the minimum estimation values in the three prediction modes (frame prediction, even field prediction and odd field prediction) for the respective template blocks. The displacement vectors for these minimum estimation values are determined as the motion vectors with respect to the template block, odd sub-template block and even sub-template block.

Structure of Test Control Section

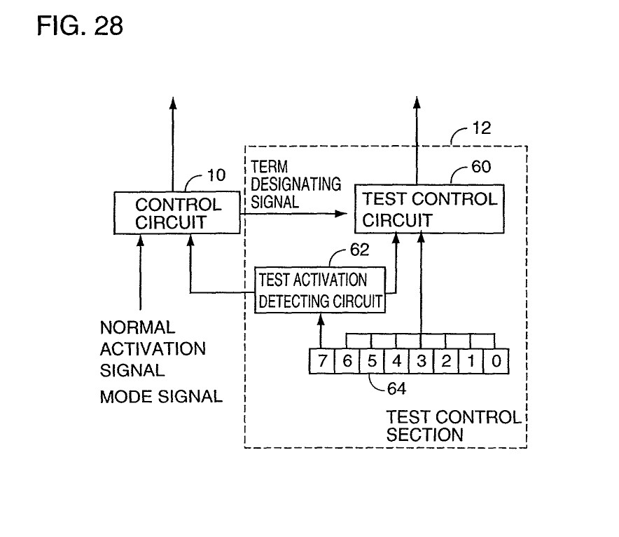

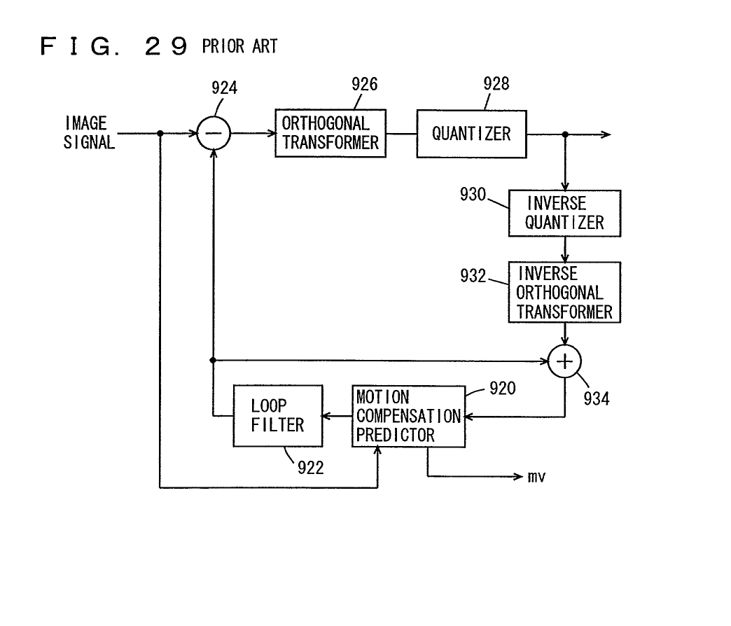

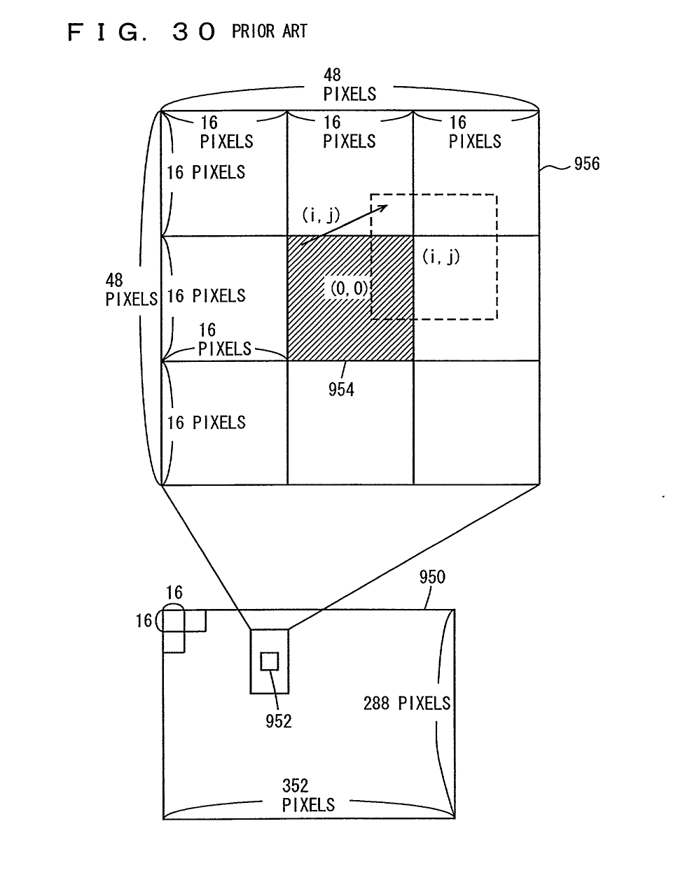

Referring to FIG. 28, test control section 12 includes: a register for testing (hereinafter, testing register) 64 for storing test control data of 8 bits (1 byte), consisting of a test activation bit (bit 7) and the other bits (bits 6:0) representing the number of times of test, externally supplied at the time of testing; a test control circuit 60 controlling input section 2 and result compressing circuit 8 during the test; and a test activation detecting circuit 62 detecting that “1” has been written in bit 7 (i.e., the test activation bit) of the test control data and designating activation of control circuit 10 and test control circuit 60.

Control circuit 10 normally performs a normal operation in receipt of a normal activation signal and a mode signal designating an operating mode. The operation of control circuit 10 when activated by test activation detecting circuit 62 is the same as in the normal operation. Control circuit 10 is configured to output a term designating signal every time an operation cycle is completed.

Test control circuit 60 starts an operation when activated by test activation detecting circuit 62. It controls test data generating circuit 2a and selectors 2d and 2e shown in FIG. 2 based on the bits 6:0 of the test control data and the term designating signal output from control circuit 10. More specifically, every time control circuit 10 outputs the term designating signal, test control circuit 60 moves to a next test cycle, causes test data generating circuit 2a to generate test data (pseudo-random number data or data of all “0”, all “1”, or combination thereof) to be used in the relevant test cycle, and further causes selectors 2d and 2e to select the output from test data generating circuit 2a.

Of the data for use in self-testing output from test data generating circuit 2a, those employing the fixed data include combinations as follows:

| SWD | TBD |
|---|---|
| all ″0″ | all ″0″ |
| all ″1″ | all ″1″ |
| all ″0″ | all ″1″ |
| all ″1″ | all ″0″ |

When any of these combinations is used for the arithmetic operation, the entire hardware portion in the operation section operates inevitably. This allows efficient testing of the entire hardware within the operation section. Test control circuit 12 makes the test executed the number of times corresponding to the value expressed by bits 6:0 of register 64, in a predetermined sequence. An exemplary sequence of the test is shown below, although the test sequence is not limited thereto.

| Number of | | |
|---|---|---|
| times of test | SWD | TBD |
| 1 | all ″0″ | all ″0″ |
| 2 | all ″1″ | all ″1″ |
| 3 | all ″0″ | all ″1″ |
| 4 | all ″1″ | all ″0″ |
| 5 and later on | pseudo-random | pseudo-random |
| | numbers | numbers |

When execution of the test by the number of times represented by bits 6:0 of register 64 is completed, test control circuit 60 automatically terminates the test. It is possible to determine whether there is a fault in the hardware of the operation section by comparing the values output from the result compressing circuit as the test results and the correct values obtained from simulation in advance.

As explained above, according to the embodiment of the present invention, the test is automatically started as the test activation bit and the number of times of test are written into the register. The entire hardware within the operation section can be tested automatically and efficiently. Further, it is unnecessary to use an external testing device for the test or to make a register within the device function as a scan path. The present invention allows efficient testing with a configuration much simpler than in the case of utilizing the register as the scan path, without an increase of the device size.

Thus, according to the present invention, it is possible to provide a motion vector detecting device which can test the hardware with high accuracy.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A motion vector detecting device with a self-testing function for detecting a motion vector of a template block within image data being processed, by searching one of image blocks in a search area within a reference image showing highest correlation with respect to said template block, comprising:
an operation circuit receiving data for said template block and data for the image blocks in said search area and calculating, by block matching, estimation values between the template block and respective ones of the image blocks in said search area to output results of the operation;
an input circuit including a select circuit selecting either one of data for testing and externally supplied data being processed, for application to said operation circuit;
a comparing circuit connected to an output of said operation circuit and, when said data being processed is applied from said select circuit to said operation circuit, comparing the operation results between said template block and the respective image blocks in said search area output from said operation circuit, to detect the motion vector of said template block;
an operation result compressing circuit connected to the output of said operation circuit and, when said data for testing is applied from said select circuit to said operation circuit, performing a predetermined operation on the operation results output from said operation circuit with respect to said data for testing, to compress the results for outputting; and
a test control circuit causing said select circuit to select one of said data being processed and said data for testing.

2. The motion vector detecting device with a self-testing function according to claim 1, wherein said operation result compressing circuit includes a summing circuit for calculating a total sum of the operation results output from said operation circuit.

3. The motion vector detecting device with a self-testing function according to claim 2, further comprising a test data generating circuit generating a pseudo-random number as test data.

4. The motion vector detecting device with a self-testing function according to claim 3, wherein said test control circuit includes
a storage circuit for storing test control data externally supplied, and
a circuit for starting the test by causing said select circuit to select said data for testing when a predetermined bit of said test control data stored in said storage circuit is a predetermined value.

5. The motion vector detecting device with a self-testing function according to claim 4, wherein said test control circuit further includes a circuit for controlling said select circuit, said operation circuit and said operation result compressing circuit such that a testing operation is repeated a number of times corresponding to a value determined by a predetermined bit of said test control data stored in said storage circuit.

6. The motion vector detecting device with a self-testing function according to claim 5, wherein
said operation circuit includes
storage elements each storing pixel data of a predetermined position in said template block and
an operation unit performing a predetermined error operation on pixel data in the image block in said search area located at the same position as the pixel data stored in said storage element and the pixel data stored in said storage element, to output a result of the operation, and
said storage element includes a D latch.

7. The motion vector detecting device with a self-testing function according to claim 1, further comprising a test data generating circuit generating a pseudo-random number as test data.

8. The motion vector detecting device with a self-testing function according to claim 1, further comprising a test data generating circuit generating predetermined fixed data as test data.

9. The motion vector detecting device with a self-testing function according to claim 1, further comprising a test data generating circuit sequentially generating and outputting combinations of all “0” and all “0”, all “1” and all “1”, all “0” and all “1”, and all “1” and all “0”, as the data for said template block and the data for the image block in said search area, respectively.

10. The motion vector detecting device with a self-testing function according to claim 1, wherein said test control circuit includes
a storage circuit for storing test control data externally supplied, and
a circuit for starting the test by causing said select circuit to select said data for testing when a predetermined bit of said test control data stored in said storing circuit is a predetermined value.

11. The motion vector detecting device with a self-testing function according to claim 1, wherein
said operation circuit includes
storage elements each storing pixel data of a predetermined position in said template block and
an operation unit performing a predetermined error operation on pixel data in the image block in said search area located at the same position as the pixel data stored in said storage element and the pixel data stored in said storage element, to output a result of the operation, and
said storage element includes a D latch.

12. A self-testing method in a motion vector detecting device for detecting a motion vector of a template block in image data being processed, by searching one of image blocks in a search area within a reference image showing highest correlation with respect to said template block, the method comprising the steps of:
selecting one of data for testing and externally supplied data being processed;
receiving the data selected in said selecting step and calculating, by block matching, estimation values between said template block and respective ones of the image blocks in said search area, and outputting calculated results;
when said data being processed is applied by said selecting step to said calculating step, comparing the calculated results between said template block and the respective image blocks in said search area output in said calculating step, and detecting the motion vector of said template block;
when said data for testing is applied by said selecting step to said calculating step, performing a predetermined operation on the calculated results output in said calculating step with respect to said data for testing, and compressing the results for outputting; and
controlling said selecting step such that said data being processed is selected normally and said data for testing is selected when testing.

13. The self-testing method in a motion vector detecting device according to claim 12, wherein said step of compressing the results for outputting includes the step of calculating a total sum of the calculated results.

14. The self-testing method in a motion vector detecting device according to claim 13, wherein said selecting step includes the step of generating and outputting a pseudo-random number as test data when testing.

15. The self-testing method in a motion vector detecting device according to claim 14, wherein said step of controlling said selecting step includes the steps of
storing externally supplied test control data, and
starting the test by controlling said selecting step such that said data for testing is selected when a predetermined bit of said test control data stored in said storing step is a predetermined value.

16. The self-testing method in a motion vector detecting device according to claim 15, wherein said step of controlling said selecting step further includes the step of repeating a testing operation a number of times corresponding to a value determined by a predetermined bit of said test control data stored in said storing step.

17. The self-testing method in a motion vector detecting device according to claim 12, wherein said selecting step includes the step of generating and outputting a pseudo-random number as test data when testing.

18. The self-testing method in a motion vector detecting device according to claim 12, wherein said selecting step includes the step of generating and outputting predetermined fixed data as test data.

19. The self-testing method in a motion vector detecting device according to claim 12, wherein said selecting step includes the step of sequentially generating and outputting combinations of all “0” and all “0”, all “1” and all “1”, all “0” and all “1”, and all “1” and all “0”, as data for said template block and data for the image block in said search area, respectively.
